(19) United States
(12) Patent Application Publication
(10) Pub. No.: US 2024/0308491 A1
(43) Pub. Date: Sep. 19, 2024

(54) UNIVERSAL TRUCK BRAKE WARNING SENSOR

(71) Applicant: Danny Thomas Redding, Uniontown, PA (US)

(72) Inventor: Danny Thomas Redding, Uniontown, PA (US)

(21) Appl. No.: 18/184,745

(22) Filed: Mar. 16, 2023

(51) Int. Cl. B60T 17/22; B60Q 9/00; F16D 66/02

(52) U.S. Cl. CPC B60T 17/22; B60Q 9/00; F16D 66/022

(57) ABSTRACT

An improved brake-wear warning sensor is disclosed. The sensor includes a predetermined length of electrically conductive wire having an end portion, a predetermined amount of insulation material having a preselected melting temperature for electrically insulating the wire, and an electrical connector secured to the end portion of the conductive wire. The connector is operatively connected to an indicator light which can either be located on a dash panel in a cab of a truck driven by an owner or operator or can be assigned to a predetermined vehicle inventory location on a panel in a control room of a truck owner or a mechanic responsible for safely maintaining a fleet of trucks.

### FIELD

The present subject matter is directed, in general to a truck-braking sensor and more particularly, is directed to an improved brake warning sensor for tractor-trailer rigs.

### BACKGROUND

Many vehicle systems use temperature sensors to determine excessive brake pad heating or wear. For instance, U.S. Pat. No. 3,674,114 to Howard is directed to a brake-lining temperature probe mounted in a brake shoe of a vehicle. The probe is responsive to wear of and temperature of a brake-lining material. A wire in the probe is connected through an appropriate control device to an indicating device in an operator's compartment of the vehicle. U.S. Pat. No. 3,689,880 to McKee et al. is directed to a vehicle brake-warning device which provides a warning signal when a brake lining becomes excessively worn or dangerously overheated. U.S. Pat. No. 4,437,547 to Harmer discloses a friction lining wear indicator for shoe-drum brakes, including a sensor mounted on a brake shoe. The sensor actuates an indicator when thickness of a friction lining on the shoe is less than a predetermined value. U.S. Pat. No. 4,562,421 to Duffy discloses a drum brake wear sensor system which senses brake wear and lights a warning light when brake-lining wear reaches a predetermined value. U.S. Pat. Nos. 5,909,171; 5,939,978; and 6,250,430, all to Kyrtsos, disclose various brake lining wear indicator systems using temperature sensor assemblies embedded in a drum brake assembly. U.S. Pat. No. 7,165,657 to Palladino discloses a thin film sensor for brake lining pad wear and brake temperature sensing. U.S. Pat. No. 9,964,168 to Pennala et al. discloses a brake pad wear and temperature sensor.

Federal Motor Carrier Safety Administration (“FMCSA”) developed compliance, safety, and accountability scores for independent medium and large truck drivers as well as trucking companies. While not aware of standardized truck components including early warning brake-overheating systems or sensors being commercially available, since part of those scores involve brake safety, such standardized components would be desirable.

Unknown status of brake wear could lead to additional truck stops or damage to components associated with a truck, and could increase hazards to drivers and the public.

### SUMMARY

The present subject matter is directed to a low-cost, improved brake-wear warning sensor that I designed to alert truck drivers and operators, truck owners, and mechanics responsible for maintaining a fleet of trucks, an early warning of conditions tending to lead overheating and wear of drum brakes and disc brakes exceeding FMCSA regulation values.

My improved brake-wear warning sensor includes: (1) a predetermined length of electrically conductive wire having an end portion, (2) a predetermined amount of insulation material having a preselected melting temperature for electrically insulating the wire, and (3) an electrical connector secured to the end portion of the conductive wire.

The connector is operatively connected to an indicator light. The indicator light can either be located on a dash panel in a cab of a truck driven by an owner or an operator or can be assigned to a predetermined vehicle inventory location on a panel in a control room of a truck owner or a mechanic responsible for safely maintaining a fleet of trucks.

### BRIEF DESCRIPTION OF THE FIGURES

FIG. 1 is a perspective view of an improved brake-wear warning sensor of the present subject matter removably fixed to an outwardly extending portion of a brake shoe.

FIG. 2 is a perspective view of the improved brake-wear warning system on an enlarged scale relative to FIG. 1 and operatively connected to an indicator light on a panel.

FIG. 3 is a perspective and exploded view on an enlarged scale relative to FIG. 1.

FIG. 4 is a sectional view looking downward along a vertical axis such as Z-Z in FIG. 1 from a plane 4-4 defined by intersecting axes such as X-X and Y-Y in FIG. 1.

FIG. 5 is a side elevational sectional view of the brake-wear sensor on an enlarged scale from a plane 5-5 defined by intersecting axes such as X-X and Y-Y in FIG. 1.

Throughout the drawing figures and detailed description which follows, I shall use similar reference numerals to refer to similar components of the present subject matter.

### DETAILED DESCRIPTION

To provide a detailed description satisfying enablement and other requirements of Title 35 of United States Code, Section 112, U.S. Pat. No. 7,734,399 to Green et al. and U.S. Pat. No. 5,877,455 to Kyrtsos are both hereby incorporated by reference in their entirety.

Referring initially to FIG. 2, I designed the present subject matter to be used in a truck having a cab. The truck could be a tractor of a tractor-and-trailer combination or “rig” commonly referred to as an eighteen-wheel rig, or simply an eighteen-wheeler, but is not limited thereto. The universal truck brake warning sensor may be used with a variety of trucks, including trucks or cabs pulling trailers, having a single axle, tandem axles, or triaxles. The truck cab generally has a dashboard, often simply referred to as a “dash”, having an indicator light that may become lit or that may flash on-and-off to notify a driver or operator of the truck of a potential problem such as low fuel or tire pressure or overheating of a brake pad.

In FIG. 2, a portion of a truck cab dashboard or “dash”, which provides information to an operator of the truck, is denoted by the reference numeral 26, and an indicator light to signal the operator of a potential operational problem with the truck, with the indicator light possibly being a light-emitting diode (LED), is denoted by the reference numeral 24.

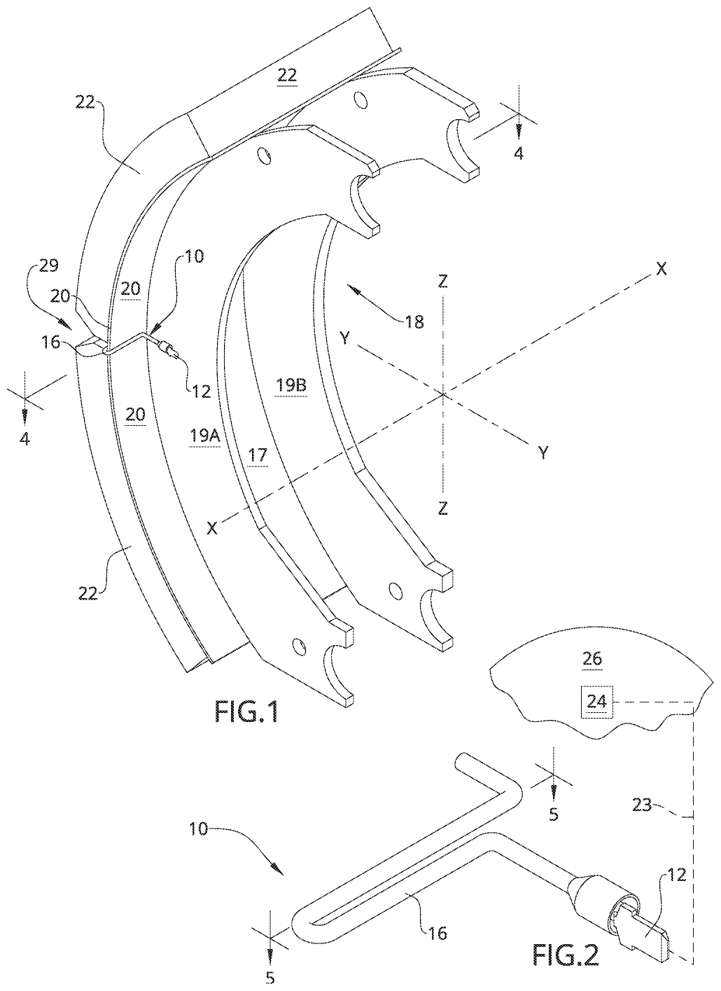

Reference is next directed to FIGS. 1, 3, 4, which illustrate a universal sensor 10 according to an embodiment of the present invention in use with drum brakes. The truck may include at least one brake shoe 18 radially arranged about a longitudinal axis X-X (FIG. 1) and adapted for operative use by an operator to stop the truck. The brake shoe 18 is shown for example purposes only, as the inventive clip may be used universally on drum brakes and disc brakes alike. The brake shoe 18 includes a backing plate 17 and a friction material 22 secured to the backing plate 17. The backing plate 17 is curvilinearly disposed about the longitudinal axis X-X and includes at least one integral rib 19A radially inwardly disposed toward the longitudinal axis X-X. (A second integral rib 19B parallel to the first rib 19A is shown in the background.) Backing plate 17 includes an integral lip 20 of predetermined thickness disposed transverse to first rib 19A.

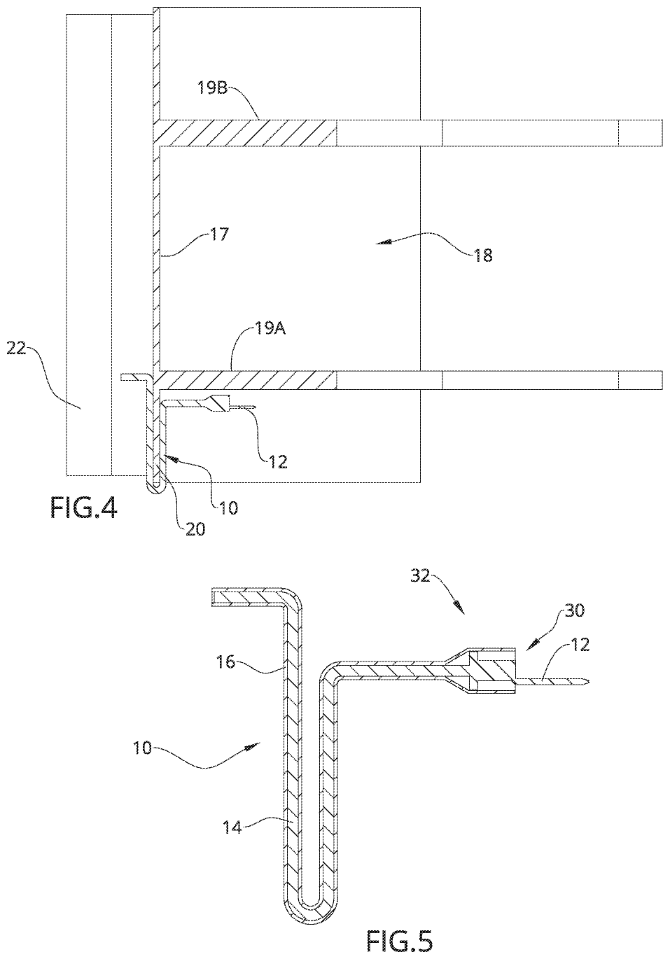

Reference is next directed to FIGS. 2, 5. An improved brake-wear warning sensor 10 of the present subject matter includes a predetermined length of electrically conductive wire 14 and a predetermined amount of an insulation material 16 for electrically insulating the wire 14. The conductive wire 14 has an end portion. The insulation material 16 can have a melting temperature of from about 500 degrees Fahrenheit (° F.) to about 700° F. For example, in some embodiments, the insulation material 16 may be PTFE (polytetrafluoroethylene) which has a melting point of 620.6° F. The warning sensor 10 of the present subject matter further includes an electrical connector 12 secured to the end portion of the conductive wire 14.

Geometric shapes for the end portion of the electrically conductive wire 14, to which the electrical connector 12 is fixed, will be dictated by operational demands upon the sensor 10. The illustrated embodiment of the wire 14 defines a T-shaped end portion 30 (FIG. 5) to which the electrical connector 12 is fixed. Since the T-shaped end portion 30 is greater in cross-section than the conductive wire 14, the insulation material 16, which normally contacts the exterior surface of the wire 14, is flared radially outwardly at 32 from a central axis of conductive wire 14 to extend around the T-shaped end portion 30. Electrical connector 12 extends outwardly axially from the T-shaped end portion 30.

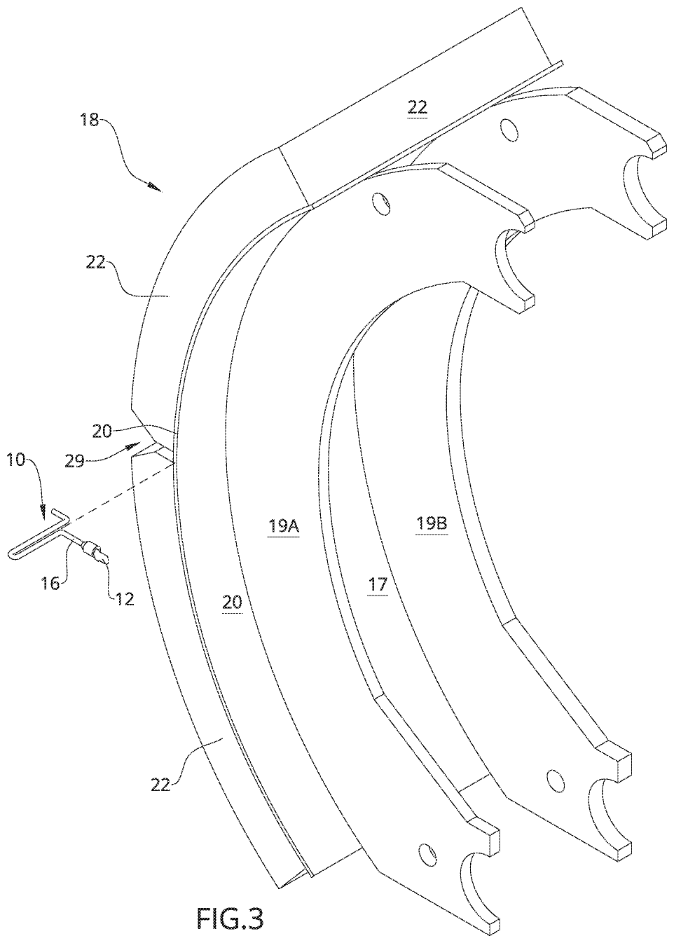

The electrical connector 12 is operatively connected by a wire or an electrical connection 23 to the indicator light 24 on dash 26. In accordance with the present subject matter, the conductive wire 14 has an inherent amount of elastic-deformation potential and the insulation material 16 has an inherent amount of friction-surface potential, so that the wire 14 can be elastically deformed for causing the insulation material 16 to be removably secured frictionally to the lip or flange 20 (which extends outwardly along the longitudinal axis X-X from the curvilinearly disposed integral rib 19A) within a V-shaped opening or niche noted by reference number 29 (FIGS. 1, 3) between abutting V-notched sections of the friction material 22 (FIG. 4). Sensor 10, when frictionally secured to the lip 20, in embodiments will sense when a brake shoe 18 overheats above about 500° F., at which temperature the insulation material 16 may begin to deteriorate. When deterioration is sufficient to cause a ground, the indicator light 24 will alert an operator of the truck that brake maintenance needs to be performed. Thus, overheating of the friction material 22 sufficient to melt the insulation material 16 electrically grounds the wire 14 and causes the indicator light 24 (or LED) to be lit, enabling corrective action to be taken.by a person. The sensor 10 may alternatively be installed on a brake pad to perform a like function in a disc brake system.

In some embodiments, the warning sensor 10 of the present subject matter can be secured to at least one brake shoe of a truck which provides a tractor portion of a tractor-and-trailer rig. In embodiments the backing plate 17 can be metal.

What has been illustrated and described in detail in this patent application is an improved brake-wear warning sensor to be used in connection with truck brakes. While the present subject matter has been described with reference to exemplary embodiments, the present subject matter is not to be limited to these embodiments. On the contrary, alternatives, changes, and/or modifications will become apparent to a person of ordinary skill in the present subject matter (“POSITA”) after this application is reviewed. Therefore, alternatives, changes, and modifications are to be treated as forming a part of the present subject matter insofar as they fall within the spirit and scope of the appended claims.

I claim:

1. In a truck having a cab and a dash (26) for providing information to an operator of the truck, wherein the dash (26) includes an indicator light (24), wherein the truck includes a braking system adapted for operative use by the operator for stopping the truck, wherein the braking system includes a brake component having a backing plate (17) and a friction material (22) secured to the backing plate (17),
an improved brake-wear warning sensor (10) comprising:
a predetermined length of electrically conductive wire (14) having an end portion;
a predetermined amount of an insulation material (16) having a melting temperature of about 500 degrees Fahrenheit (° F.) to about 700° F. formed around the wire,
wherein the conductive wire (14) has an inherent amount of elastic-deformation potential and the insulation material (16) an inherent amount of friction-surface potential that the wire (14) can be elastically deformed for causing the insulation material (16) to be secured frictionally to the brake component; and
an electrical connector (12) secured to the end portion of the conductive wire (14) and operatively connected to the indicator light (24),
wherein overheating of the friction material (22) sufficient to melt the insulation material (16) electrically grounds the wire (14) and causes the indicator light (24) to be lit.

2. The brake-wear warning sensor of claim 1, wherein the truck is a tractor portion of a tractor-and-trailer rig.

3. The brake-wear warning sensor of claim 1, wherein the backing plate (17) is metal.

4. A brake-wear warning sensor (10) comprising:
a predetermined length of electrically conductive wire (14) formed with a first 90° bend, and a second 90° bend, and a 180° bend therebetween, said electrically conductive wire (14) having an end portion;
a predetermined amount of an insulation material (16) having a melting temperature of about 500 degrees Fahrenheit (° F.) to about 700° F. formed around the wire,
wherein the conductive wire (14) has an inherent amount of elastic-deformation potential and the insulation material (16) an inherent amount of friction-surface potential that the wire (14) can be elastically deformed for causing the insulation material (16) to be secured frictionally to a brake component; and
an electrical connector (12) secured to the end portion of the conductive wire (14) and operative to electronically connect to an indicator light (24),
wherein heat sufficient to melt the insulation material (16) exposes the wire (14).

5. The brake-wear warning sensor (10) of claim 4, wherein a first length between the first 90° bend and the 180° bend is greater than a second length between the 180° bend and the second 90° bend.
